(19) United States
(12) Patent Application Publication
(10) Pub. No.: US 2014/0286307 A1
(43) Pub. Date: Sep. 25, 2014

(54) METHODS FOR RAPIDLY SWITCHING BETWEEN DIFFERENT RATS AND COMMUNICATIONS APPARATUSES UTILIZING THE SAME

(71) Applicant: MediaTek Inc., Hsin-Chu (TW)

(72) Inventors: Hung-Yueh CHEN, Taipei City (TW); Chi-Chen LEE, Taipei City (TW)

(73) Assignee: MediaTek Inc., Hsin-Chu (TW)

(21) Appl. No.: 14/188,918

(22) Filed: Feb. 25, 2014

Related U.S. Application Data
(60) Provisional application No. 61/804,411, filed on Mar. 22, 2013.

(51) Int. Cl. H04W 36/00

(52) U.S. Cl. CPC H04W 36/0022; H04W 36/0083
USPC 370/331

(57) ABSTRACT

A communications apparatus includes an RF signal processing device, a baseband signal processing device and a processor. The processor controls operations of the RF signal processing device and the baseband signal processing device, camps on a first cell of a first RAT, receives a mobile terminated (MT) or mobile originated (MO) service request and determines whether performing a RAT change procedure to switch from the first RAT to a second RAT is required. When determining that performing the RAT change procedure is required, the processor directly camps on a target cell of the second RAT and transmits a MT or MO service response for responding the MT or MO service request to the target cell.

### CROSS REFERENCE TO RELATED APPLICATIONS

This application claims the benefit of U.S. Provisional Application No. 61/804,411 filed Mar. 22, 2013 and entitled “System Information Early Reading for CSFB”, the entire contents of which are hereby incorporated by reference.

### BACKGROUND OF THE INVENTION

1. Field of the Invention

The invention relates to communications apparatuses and methods for the communications apparatuses to rapidly switch between different RATs (Radio Access Technologies).

2. Description of the Related Art

The evolution of wireless communications technologies often requires that newer systems and networks be compatible with existing systems and networks. A communications specification defining the operation of new technology often provides requirements for the new system to interface with these legacy systems. For example, the 3GPP Long Term Evolution (LTE) standard requires that a wireless communications device be able to use circuit switched networks for voice calls as well as utilize the LTE network. For example, LTE allows a circuit switched fall back (CSFB) procedure, in which an LTE handset can leverage the existing infrastructure of previous 2G or 3G technologies to make or receive voice calls. In other words, the LTE handset can end an existing LTE connection with an LTE evolved Node B (eNB) and fall back to a 2G or 3G cell (e.g., Node B or base station). During the CSFB procedure, the LTE session is suspended. Upon completion of the call, the LTE handset can then re-establish a connection with the LTE network. For another example, some operators may require a wireless communications device to be able to transfer a circuit switched service from a 3G network to a 2G network due to the 3G network not being as widely distributed as the 2G network or the 3G network being configured to only provide packet switched services.

When switching between different radio access technologies (RATs) is required, for example, switching from 4G to 3G/2G or switching from 3G to 2G as in the examples given above, a long delay time usually occurs. A long delay time can be frustrating for the user and can degrade the overall communications performance.

Therefore, methods for shortening the delay time and rapidly switching between different RATs are proposed.

### BRIEF SUMMARY OF THE INVENTION

Communications apparatuses and methods for communications apparatuses to rapidly switch between different RATs are provided. An embodiment of a communications apparatus comprises an RF signal processing device, a baseband signal processing device and a processor. The processor controls operations of the RF signal processing device and the baseband signal processing device, camps on a first cell of a first RAT, receives a mobile terminated (MT) or mobile originated (MO) service request and determines whether performing a RAT change procedure to switch from the first RAT to a second RAT is required. When determining that performing the RAT change procedure is required, the processor directly camps on a target cell of the second RAT and transmits a MT or MO service response for responding the MT or MO service request to the target cell.

An embodiment of a method for a communications apparatus in a network environment comprising a plurality of cells belonging to different radio access technologies (RATs) to rapidly switch between different RATs, comprises: camping on a first cell of a first RAT; receiving a mobile terminated (MT) or mobile originated (MO) service request; determining whether performing a RAT change procedure to switch from the first RAT to a second RAT is required; and when performing the RAT change procedure is required, directly camping on a target cell of the second RAT and transmitting a MT or MO service response for responding the MT or MO service request to the target cell.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a block diagram of a communications apparatus according to an embodiment of the invention;

FIG. 2 shows a flow chart of a method for a communications apparatus in a network environment comprising a plurality of cells belonging to different RATs to rapidly switch between different RATs according to the first aspect of the invention;

FIG. 3 shows an exemplary SI early-reading database according to an embodiment of the invention;

FIG. 4A shows a conventional message flow for a communications apparatus to respond to a paging;

FIG. 4B shows a message flow for a communications apparatus to respond to a paging when applying a fast RAT change procedure according to an embodiment of the invention;

FIG. 5 shows a flow chart of a method for a communications apparatus in a network environment comprising a plurality of cells belonging to different RATs to rapidly switch between different RATs according to the second aspect of the invention;

FIG. 6 shows another flow chart of a method for a communications apparatus in a network environment comprising a plurality of cells belonging to different RATs to rapidly switch between different RATs according to the second aspect of the invention;

FIG. 7A and FIG. 7B show yet another flow chart of a method for a communications apparatus in a network environment comprising a plurality of cells belonging to different RATs to rapidly switch between different RATs according to the first and second aspects of the invention;

FIG. 8 shows an exemplary CSFB flow chart with the proposed SI early-reading procedure and the proposed fast RAT change procedure applied according to an embodiment of the invention; and

FIG. 9 shows another exemplary CSFB flow chart with the proposed SI early-reading procedure and the proposed fast RAT change procedure applied according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

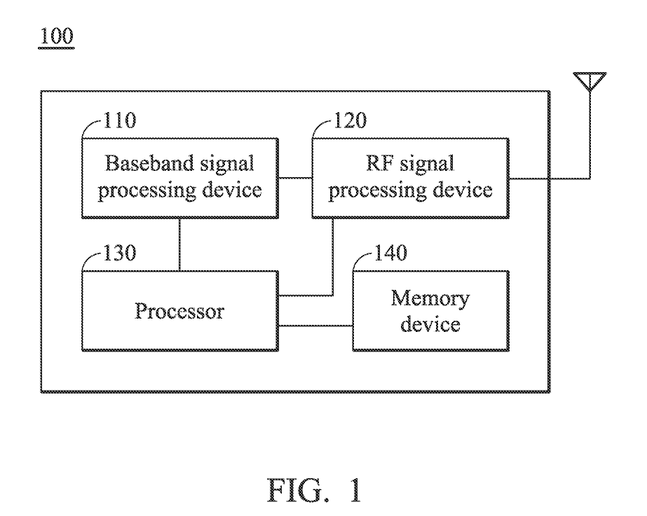

FIG. 1 shows a block diagram of a communications apparatus according to an embodiment of the invention. The communications apparatus 100 may be a notebook, a cellular phone, a portable gaming device, a portable multimedia player, a Global Positioning System (GPS), a receiver, a personal digital assistant, a tablet computer, or another such device. The communications apparatus 100 may comprise at least a baseband signal processing device 110, a radio frequency (RF) signal processing device 120, a processor 130, a memory device 140, and an antenna module comprising at least one antenna. Note that, in order to clarify the concept of the invention, FIG. 1 presents a simplified block diagram in which only the elements relevant to the invention are shown. However, the invention should not be limited to what is shown in FIG. 1.

The RF signal processing device 120 may receive RF signals via the antenna and process the received RF signals to convert the received RF signals to baseband signals to be processed by the baseband signal processing device 110, or receive baseband signals from the baseband signal processing device 110 and convert the received baseband signals to RF signals to be transmitted to a peer communications apparatus. The RF signal processing device 120 may comprise a plurality of hardware elements to perform radio frequency conversion. For example, the RF signal processing device 120 may comprise a power amplifier, a mixer, or others.

The baseband signal processing device 110 may further process the baseband signals to obtain information or data transmitted by the peer communications apparatus. The baseband signal processing device 110 may also comprise a plurality of hardware elements to perform baseband signal processing. The baseband signal processing may comprise analog-to-digital conversion (ADC)/digital-to-analog conversion (DAC), gain adjustment, modulation/demodulation, encoding/decoding, and so on.

The processor 130 may control the operations of the baseband signal processing device 110 and the RF signal processing device 120. According to an embodiment of the invention, the processor 130 may also be arranged to execute the program codes of the software module(s) of the corresponding baseband signal processing device 110 and/or the RF signal processing device 120. The program codes accompanied with specific data in a data structure may also be referred to as a processor logic unit or a stack instance when being executed. Therefore, the processor 130 may be regarded as being comprised of a plurality of processor logic units, each for executing one or more specific functions or tasks of the corresponding software module(s). The memory device 140 may store the software and firmware program codes, system data, user data, etc . . . of the communications apparatus 100.

According to an embodiment of the invention, the RF signal processing device 120 and the baseband signal processing device 110 may be collectively regarded as a radio module capable of communicating with a wireless network to provide wireless communications services in compliance with a predetermined Radio Access Technology (RAT). Note that, in some embodiments of the invention, the communications apparatus 100 may further be extended to comprise more than one antenna and/or more than one radio module, and the invention should not be limited to what is shown in FIG. 1.

In addition, in some embodiments of the invention, the processor 130 may be configured inside of the baseband signal processing device 110, or the communications apparatus 100 may comprise another processor configured inside of the baseband signal processing device 110. Thus the invention should not be limited to the architecture as shown in FIG. 1.

According to an embodiment of the invention, the communications apparatus 100 may be in a network environment comprising a plurality of cells belonging to different radio access technologies (RATs). The communications apparatus 100 may perform a RAT change procedure to switch communications services between two different RATs for a number of reasons. For example, the communications apparatus 100 may perform a RAT change procedure to switch communications services from 2G to 3G or 4G so as to achieve better packet switched (PS) performance. For another example, the communications apparatus 100 may perform a RAT change procedure to switch communications services from 4G to 2G or 3G when the communications apparatus 100 or the 4G network does not support the Voice over LTE (VoLTE). For yet another example, the communications apparatus 100 may perform RAT change to switch communications services from one RAT to another when the signal quality of the current RAT is not good enough.

Suppose that the communications apparatus 100 originally camps on a first cell of a first RAT, and when required, switches its communications services to a second cell of a second RAT. An important focus is placed on the methods to shorten the delay time of the RAT change procedure and camp on the second cell as fast as possible. In the following paragraphs, methods for fast switching between different RATs will be introduced and discussed.

Aiming to shorten the delay time required for performing a RAT change procedure so as to achieve the goal of rapidly switching between different RATs, two basic concepts are proposed: one is a novel System Information (SI) early reading concept (the first aspect of the invention) and the other one is a novel fast RAT change procedure (the second aspect of the invention).

According to the first aspect of the invention, the communications apparatus 100 (or, the processor 130 of the communications apparatus 100) may acquire, receive or read the SI of one or more neighboring cells of the second RAT (and/or any RAT other than the first RAT) in advance, and store the SI in an SI early-reading database. When the processor 130 determines that performing a RAT change procedure to switch from the first RAT to the second RAT is required, the processor 130 may perform the RAT change procedure and camp on a target cell of the second RAT based on the SI previously stored in the SI early-reading database.

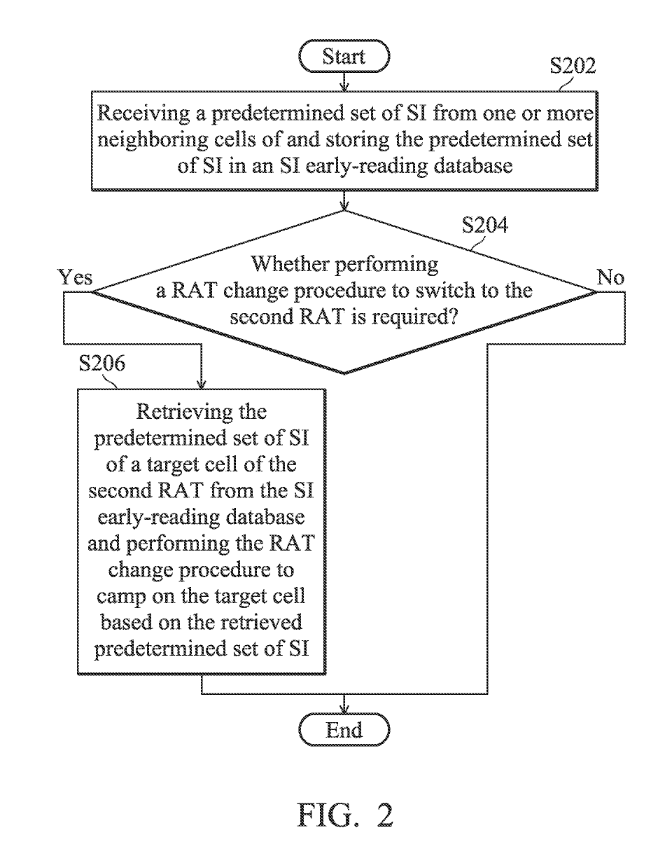

FIG. 2 shows a flow chart of a method for a communications apparatus in a network environment comprising a plurality of cells belonging to different radio access technologies (RATs) to rapidly switch between different RATs according to the first aspect of the invention. Suppose that the communications apparatus 100 currently camps on a first cell of a first RAT. The processor 130 may receive a predetermined set of system information (SI) from one or more neighboring cells and store the predetermined set of SI in an SI early-reading database (Step S202).

In one embodiment of the invention, step S202 may be performed anytime when RF signal processing resources (for example, the RF signal processing device 120 and the antenna) of the communications apparatus 100 are not occupied for any other signal transceiving procedure. Note that step S202 may be performed when the communications apparatus 100 operates in either an idle mode or a connected mode, and the invention should not be limited thereto. When the communications apparatus 100 operates in the connected mode, the processor 130 may use some gap time to perform the step S202.

In another embodiment of the invention, step S202 may also be performed during the time when the processor was performing another RAT change procedure. To be more specific, the SI received in a previous RAT change procedure may be stored in the SI early-reading database for future use. In yet another embodiment of the invention, step S202 may also be performed when the communications apparatus 100 was camping on another cell. To be more specific, the SI of a cell that the communications apparatus 100 has camped on before may be stored in the SI early-reading database for future use. In still another embodiment of the invention, step S202 may also be performed when the processor 130 determines that a mobile originated (MO) service request, such as an MO CS call request or an MO PS call request, is possibly going to be triggered. For example, the processor 130 may determine that an MO service request is possibly going to be triggered when the user is browsing the phonebook records of the communications apparatus 100, opening a number-dialing user interface, executing any application programs that will trigger the user to establish a PS or CS connection, or the like. When determining that an MO service request is possibly to be triggered, the processor 130 may perform step S202 so as to collect the predetermined set of SI of one or more neighboring cells in advance.

Next, the processor 130 may further determine whether performing a RAT change procedure to switch from the first RAT to the second RAT is required (Step S204). If not, the flow may be ended or may return to step S202 to keep collecting SI in the SI early-reading database. If yes, the processor 130 may retrieve the predetermined set of SI of a target cell of the second RAT from the SI early-reading database and perform the RAT change procedure to camp on the target cell based on the retrieved predetermined set of SI (Step S206). When the SI of the target cell is already received and stored in the SI early-reading database, the processor 130 does not have to receive the SI from the target cell during the RAT change procedure. Therefore, the delay time required for performing the RAT change procedure can be greatly reduced and the goal of rapidly switching between different RATs can be achieved.

According to an embodiment of the invention, the predetermined set of SI may be a full set of SI, a minimal set of SI, or others. For example, the predetermined set of SI may comprise all the SI broadcast by the corresponding neighboring cell. For another example, the predetermined set of SI may comprise all the SI broadcast by the corresponding neighboring cell and necessary for the communications apparatus 100. To be more specific, in step S202, the processor 130 may not receive the SI for the features that are not supported by the communications apparatus 100. For yet another example, the predetermined set of SI may be a minimal set of SI which is broadcast by the corresponding neighboring cell and is necessary for the processor 130 to establish a CS or a PS connection with the corresponding neighboring cell.

According to an embodiment of the invention, in step S204, the processor 130 may determine whether performing a RAT change procedure is required based on some different criteria. For example, the processor 130 may determine a RAT change procedure is required when performing a CSFB is required. For another example, the processor 130 may determine a RAT change procedure is required when a current signal quality of the currently camped on cell is bad. For yet another example, the processor 130 may determine that a RAT change procedure is required when a current signal quality of a neighbor cell is much better than a current signal quality of the currently camped on cell. For yet another example, the processor 130 may determine a RAT change procedure is required when the network request the communications apparatus 100 to do so.

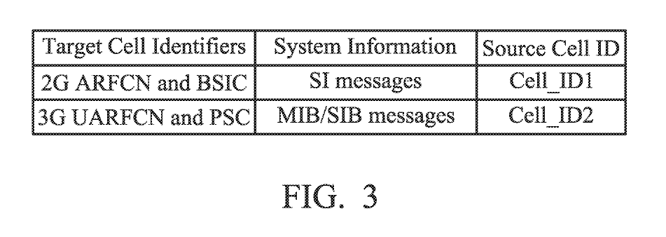

FIG. 3 shows an exemplary SI early-reading database according to an embodiment of the invention. Note that in the embodiment, the SI early-reading database is represented as a table; however, the invention should not be limited thereto. According to an embodiment, the SI early-reading database may comprise a plurality of records, and each record corresponds to a specific cell. The “Target Cell Identifiers” field records a radio frequency carrier number and a base station identity code (BSIC) or a primary scrambling code (PSC) of the specific cell. The radio frequency carrier number may be the Absolute Radio Frequency Carrier Number (ARFCN) for 2G, UTRA Absolute Radio Frequency Channel Number (UARFCN) for 3G, EUTRA Absolute Radio Frequency Channel Number (EARFCN) for 4G, or others. The “System Information” field records the predetermined set of SI of the specific cell. The “Source Cell ID” field records an identifier of the currently camped on cell. Note that since the BSIC and PSC may be reused in different geographic areas, the identifier of the currently camped on cell should be recorded, accordingly. When retrieving SI from the SI early-reading database, the processor 130 may check the “Source Cell ID” field first so as to find out if the records having the Source Cell ID matches with the cell ID of the currently camped on cell. Next, the processor 130 may check the “Target Cell Identifiers” field of the found records so as to find out the record of the target cell.

According to an embodiment of the invention, for reducing power consumption when performing SI early-reading, the processor 130 may receive the SI of only a portion of the neighbor cells. For example, the processor may receive the SI of a previous target cell decided in a previous RAT change procedure, such as a previous “CSFB target cell” indicated by the 4G network in the previous CSFB procedures. For another example, the processor may receive the SI of only the cell with the strongest signal quality among a plurality of neighboring cells of one RAT. For yet another example, the processor may receive the SI of one or more neighboring cells with a signal quality that is better than a predetermined threshold.

According to an embodiment of the invention, the processor 130 may further start a “re-reading” timer for each cell or a group of cells in the SI early-reading database. When the “re-reading” timer expires, the processor 130 may acquire, receive or read the system information messages again to check if any parameter has been changed. The period of the re-reading timer may initially be set to a first reading period. When the re-reading timer expires, the processor 130 may re-start the timer with a new period. If the processor 130 finds that the system information message has been changed, the new period may be set to a value which is same as or shorter than the first reading period. Otherwise (i.e., if the system information message has not been changed), the new period may be set to a value which is the same as or longer than the first reading period.

According to the second aspect of the invention, when performing the RAT change procedure is required, the communications apparatus 100 (or, the processor 130 of the communications apparatus 100) may directly camp on the target cell without notifying the first cell.

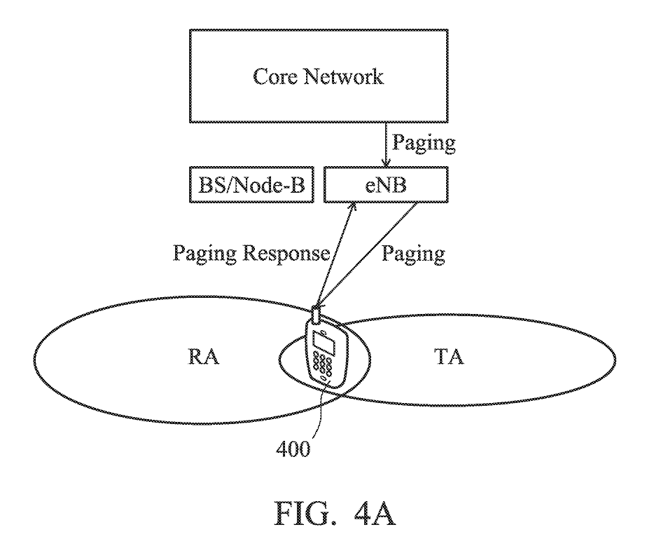

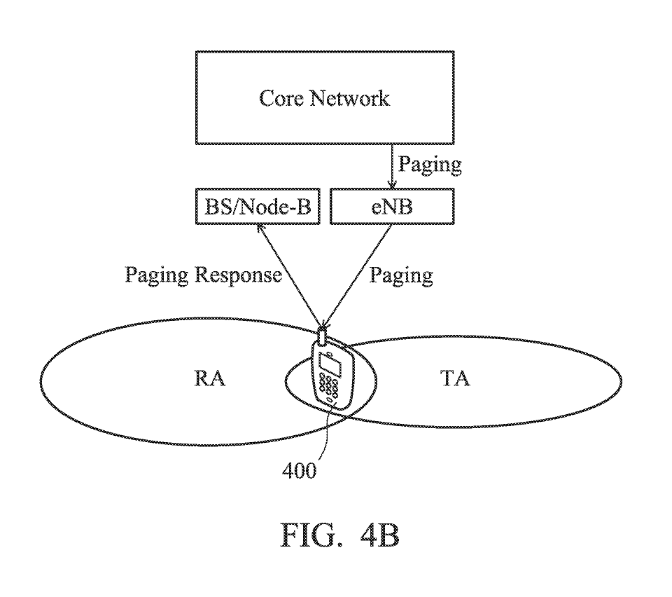

FIG. 4A shows a conventional message flow for a communications apparatus to respond to a paging. FIG. 4B shows a message flow for a communications apparatus to respond to a paging when applying a fast RAT change procedure according to an embodiment of the invention. As shown in FIG. 4A, when the eNB of the 4G network receives a paging (for example, a CS paging) from the core network, the eNB may page the communications apparatus 400. Conventionally, upon receiving the paging from the eNB, the communications apparatus 400 has to establish a dedicated connection with the eNB (when the dedicated connection has not been established) and then respond with a paging to the eNB. However, since the eNB cannot support CS service, a CSFB procedure is triggered and the communications service is transferred to the legacy network.

Referring to FIG. 4B, according to an embodiment of the invention, when the fast RAT change procedure is performed, upon receiving the paging from the eNB, the communications apparatus 400 may directly camp on the 2G/3G cell and respond with the paging to the 2G/3G base station (BS) or the Node-B instead of responding the paging to the eNB as shown in FIG. 4A. Note that it is workable to directly camp on the 2G/3G cell and respond with the paging to the 2G/3G cell without notifying the 4G cell since the paging response is finally routed to the Mobile Switching Center (MSC) in the core network, no matter whether the paging response is received by the 2G/3G cell or the 4G cell. In addition, it is especially workable when the Idle state Signaling Reduction (ISR) is supported by and activated at both the network side and the communications apparatus 400. When the ISR is supported and activated, the BS or the Node-B may also receive the paging from the core network.

Since the communications apparatus 400 does not establish a dedicated connection with the eNB and respond with the paging to the eNB, the delay time required for performing the RAT change procedure can be greatly reduced and the goal of rapidly switching between different RATs can be achieved. Note that although FIG. 4B shows the examples of applying the fast RAT change procedure when the communications apparatus receives an MT service request, the invention should not be limited thereto. As will be introduced below, the fast RAT change procedure may also be applied when the communications apparatus receives an MO service request.

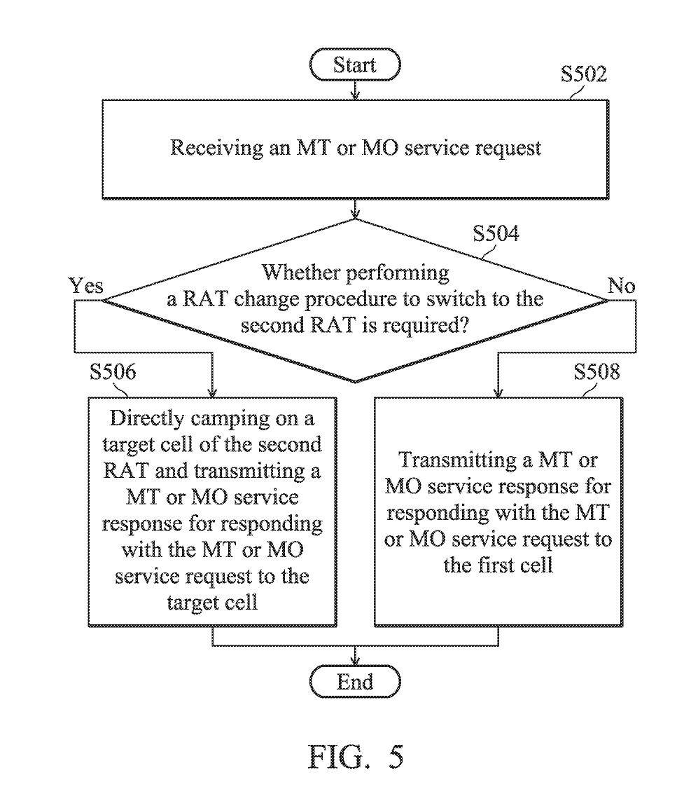

FIG. 5 shows a flow chart of a method for a communications apparatus in a network environment comprising a plurality of cells belonging to different RATs to rapidly switch between different RATs according to the second aspect of the invention. Suppose that the communications apparatus 100 currently camps on a first cell of a first RAT. Upon receiving a mobile terminated (MT) or mobile originated (MO) service request (Step S502), the processor 130 may determine whether performing a RAT change procedure to switch from the first RAT to a second RAT is required (Step S504). Note that the service request may be either the CS service request or the PS service request. Note further that the processor 130 may receive an MO service request when the user press the dial key or enter a dial command to request a CS call service, or press the execute key or enter a connect command to request a PS call service, or the like.

In the embodiment of the invention, when performing the RAT change procedure is required and when the processor 130 determines to perform a fast RAT change procedure, the processor 130 may directly camp on a target cell of the second RAT and transmit a MT or MO service response for responding to the MT or MO service request to the target cell (Step S506). As previously described, the processor 130 may directly camp on a target cell of the second RAT without notifying the first cell, and the responding with the MT or MO service request to the target cell instead of to the first cell. Therefore, there is no need for the processor 130 to establish a dedicated connection with the first cell. On the other hand, when performing the RAT change procedure is not required, the processor 130 may transmit the MT or MO service response for responding the MT or MO service request to the first cell (Step S508).

Note that the target cell may be determined from a plurality of neighboring cells by the processor 130 based on any predetermined algorithm as well known in the art, and the invention should not be limited to any specific algorithm.

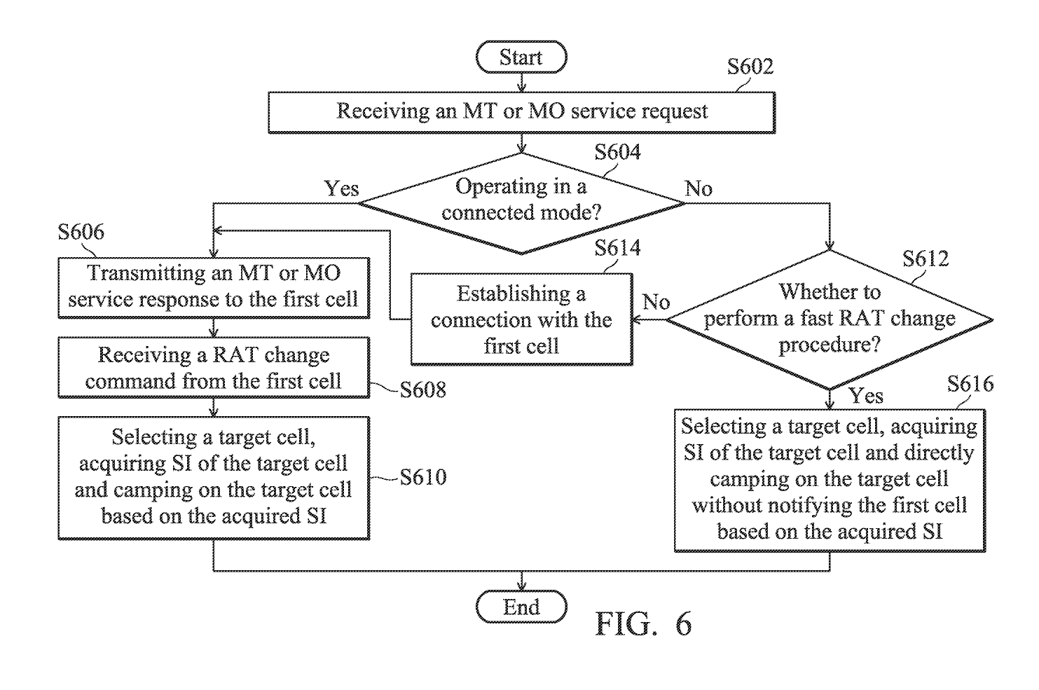

FIG. 6 shows another flow chart of a method for a communications apparatus in a network environment comprising a plurality of cells belonging to different RATs to rapidly switch between different RATs according to the second aspect of the invention. Suppose that the communications apparatus 100 currently camps on a first cell of a first RAT and suppose that performing a RAT change procedure is required when receiving a mobile terminated (MT) or mobile originated (MO) service request. Upon receiving an MT or MO service request (Step S602), the processor 130 may determine whether the communications apparatus 100 operates in a connected mode (Step S604). If so, the processor 130 may transmit a MT or MO service response for responding the MT or MO service request to the first cell (Step S606). Next, the processor 130 may optionally receive a RAT change command from the first cell when required (Step S608). The RAT change command may be, for example but not limited to, the Cell Change Order (CCO) or redirection command. Next, the processor 130 may select a target cell, and optionally acquire, receive or read system information of the target cell and then camp on the target cell based on the acquired (or, received or read) system information to complete the RAT change procedure (Step S610).

On the other hand, when the communications apparatus 100 does not operate in the connected mode, the processor 130 may further determine whether to perform a fast RAT change procedure (Step S612). The algorithms for determining whether to perform the fast RAT change procedure will be discussed further in the following paragraphs. When the processor determines not to perform the fast RAT change procedure, the processor 130 may establish a connection with the first cell (Step S614), and then the flow goes to step S606. When the processor determines to perform the fast RAT change procedure, the processor 130 may select a target cell, acquire (or, receive or read) system information of the target cell and then directly camp on the target cell based on the acquired (or, received or read) system information without notifying the first cell as discussed above to complete the fast RAT change procedure (Step S616).

In some embodiments of the invention, the SI early-reading database may also be applied in the fast RAT change procedure to further shorten the delay time of the RAT change procedure.

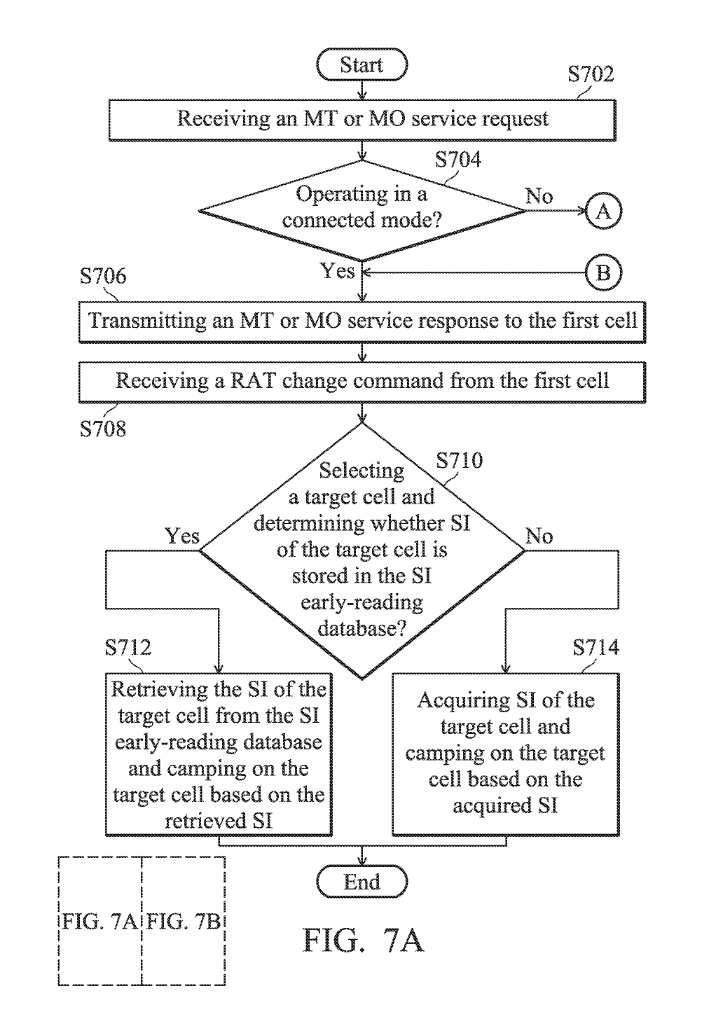

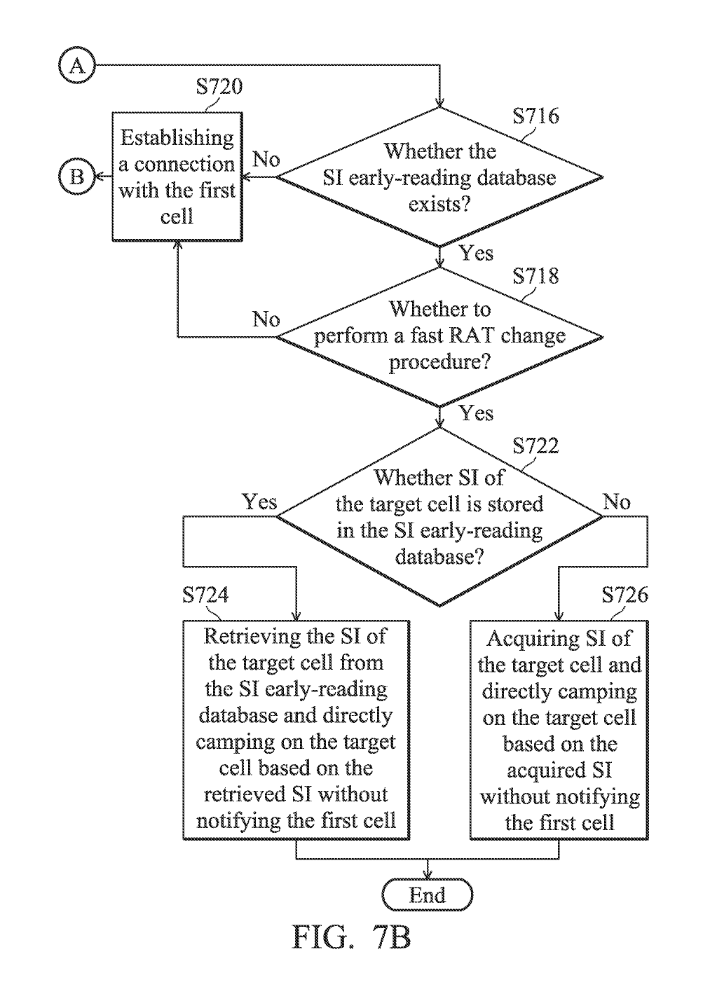

FIG. 7A and FIG. 7B show yet another flow chart of a method for a communications apparatus in a network environment comprising a plurality of cells belonging to different RATs to rapidly switch between different RATs according to the first and second aspects of the invention. Suppose that the communications apparatus 100 currently camps on a first cell of a first RAT and suppose that performing a RAT change procedure is required when receiving a mobile terminated (MT) or mobile originated (MO) service request. Upon receiving an MT or MO service request (Step S702), the processor 130 may determine whether the communications apparatus 100 operates in a connected mode (Step S704). If so, the processor 130 may transmit an MT or MO service response for responding with the MT or MO service request to the first cell (Step S706). Next, the processor 130 may optionally receive a RAT change command from the first cell when required (Step S708). The RAT change command may be, for example but not limited to, the Cell Change Order (CCO) or redirection command. Next, the processor 130 may further select a target cell and determine whether SI of the target cell is stored in the SI early-reading database (Step S710). As previously described, when retrieving SI from the SI early-reading database, the processor 130 may check the “Source Cell ID” field first so as to find out the records having the Source Cell ID matches with the cell ID of the currently camped on first cell. Next, the processor 130 may check the “Target Cell Identifiers” field of the found records so as to find out the record of the target cell.

If so, the processor 130 may retrieve the SI of the target cell from the SI early-reading database and then camp on the target cell based on the retrieved SI to complete the RAT change procedure (Step S712). If not, the processor 130 may acquire (or, receive or read) system information of the target cell and then camp on the target cell based on the acquired (or, received or read) system information to complete the RAT change procedure (Step S714).

On the other hand, when the communications apparatus 100 does not operate in the connected mode, the processor 130 may further determine whether the SI early-reading database exists (Step S716). If so, the processor 130 may further determine whether to perform a fast RAT change procedure (Step S718). When the SI early-reading database does not exist, or when the processor 130 determines not to perform the fast RAT change procedure, the processor 130 may establish a connection with the first cell (Step S720), and then the flow goes to step S706. Note that Step S716 is an optional step. That is, in some embodiments, the Step S716 may be skipped.

When the processor 130 determines to perform the fast RAT change procedure, the processor 130 may select a target cell and determine whether SI of the target cell is stored in the SI early-reading database (Step S722). If so, the processor 130 may retrieve the SI of the target cell from the SI early-reading database and then directly camp on the target cell based on the retrieved SI without notifying the first cell to complete the fast RAT change procedure (Step S724). If not, the processor 130 may acquire (or, receive or read) system information of the target cell and then directly camp on the target cell based on the acquired (or, received or read) system information without notifying the first cell to complete the fast RAT change procedure (Step S726).

According to an embodiment of the invention, the processor 130 may determine whether to perform an SI early-reading procedure, for receiving a predetermined set of SI from one or more neighboring cells and storing the predetermined set of SI in an SI early-reading database as discussed above, and/or determine whether to perform the fast RAT change procedure based on some criteria as listed below:

1). Settings of the user of the communications apparatus 100,

2). Settings of the manufacturer of the communications apparatus 100,

3). The decision algorithm executed on the communications apparatus 100 regarding the network operator,

4). The decision algorithm executed on the communications apparatus 100 regarding geographical information,

5). The decision algorithm executed on the communications apparatus 100 regarding country information,

6). The decision algorithm executed on the communications apparatus 100 regarding to network deployment (e.g., location area (LA), routing area (RA), tracking area (TA), and cell ID),

7). The decision algorithm executed on the communications apparatus 100 regarding to surrounding network environment (e.g., whether a specific RAT is present in the surrounding network environment or not)

8). The decision algorithm executed on the communications apparatus 100 regarding to the supported RAT of the communications apparatus 100,

9). The decision algorithm executed on the communications apparatus 100 regarding to the features supported by the network,

10). The volume of the remaining battery power,

11). Whether the communications apparatus 100 is set to voice centric or data centric,

12). Whether that ISR is supported and activated.

Note that in some embodiments, whether the SI early-reading database exists may also be used as one of the criteria for determining whether to perform the fast RAT change procedure. For example, when the SI early-reading database does not exist, the processor 130 may determine not to perform the fast RAT change procedure.

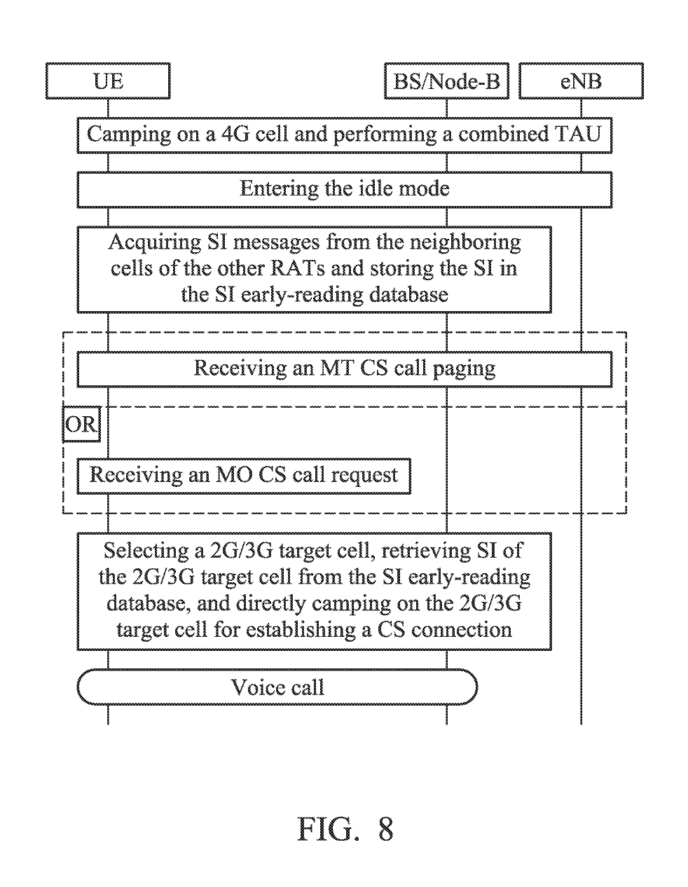

FIG. 8 shows an exemplary CSFB flow chart with the proposed SI early-reading procedure and the proposed fast RAT change procedure applied according to an embodiment of the invention. In the embodiment, the communications apparatus 100 operates in an idle mode and the UE in the flow chart represents the communications apparatus 100. After camping on a 4G cell and performing a combined tracking area and location area update (TAU), the UE enters an idle mode. Next, the UE starts acquiring (or, receiving or reading) SI messages of the neighboring cells of the other RATs and storing the SI in the SI early-reading database. Upon receiving an MT CS call paging or receiving an MO CS call request, the UE may select a 2G or 3G target cell, retrieve SI of the 2G/3G target cell from the SI early-reading database, and directly camp on (or, select to) the 2G/3G target cell for establishing a CS connection via the 2G/3G cell. Finally, the voice call can proceed between the UE and the 2G/3G network. Note that since the UE does not have to acquire (or receive or read) the SI of the target cell during the CSFB procedure and the UE directly camps on the 2G/3G target cell without establishing a dedicated connection with the 4G cell, the overall delay time of performing the CSFB procedure is greatly reduced.

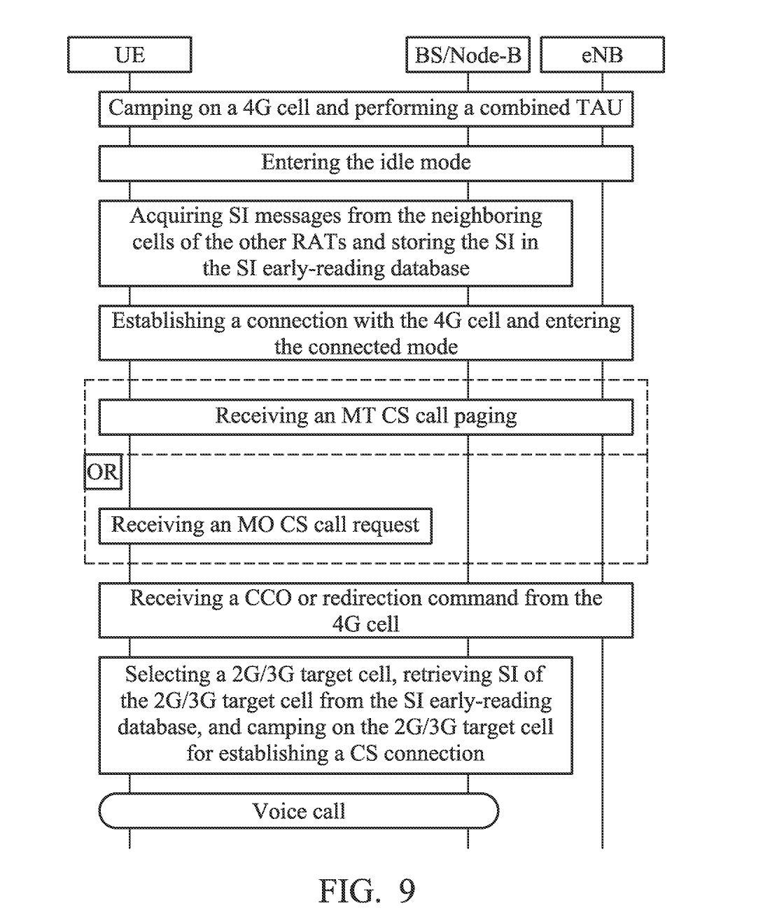

FIG. 9 shows another exemplary CSFB flow chart with the proposed SI early-reading procedure and the proposed fast RAT change procedure applied according to another embodiment of the invention. In the embodiment, the communications apparatus 100 operates in a connected mode and the UE in the flow chart represents the communications apparatus 100. After camping on a 4G cell and performing a combined tracking area and location area update (TAU), the UE enters an idle mode. Next, the UE starts acquiring (or, receiving or reading) SI messages of the neighboring cells of the other RATs and storing the SI in the SI early-reading database. Next, the UE establishes a connection with the 4G cell and enters a connected mode. Upon receiving an MT CS call paging or receiving an MO CS call request, the UE may receive a CCO or redirection command from the 4G cell. The 4G network may assign one or more 2G/3G preferred cells in the CCO or redirection command. The UE may select a target cell from the one or more preferred cells, retrieve SI of the 2G/3G target cell from the SI early-reading database, and camp on (or select to) the 2G/3G target cell for establishing a CS connection. Finally, the voice call can proceed between the UE and the 2G/3G network. Note that since the UE does not have to acquire (or, receive or read) the SI of the target cell during the CSFB procedure, the delay time of performing the CSFB procedure is greatly reduced.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

The above-described embodiments of the present invention can be implemented in any of numerous ways. For example, the embodiments may be implemented using hardware, software, or a combination thereof It should be appreciated that any component or collection of components that perform the functions described above can be generically considered as one or more processors that control the above-discussed function. The processor(s) can be implemented in numerous ways, such as with dedicated hardware, or with general-purpose hardware that is programmed using microcode or software to perform the functions recited above.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A communications apparatus in a network environment comprising a plurality of cells belonging to different radio access technologies (RATs), comprising:
a radio frequency (RF) signal processing device, processing a plurality of RF signals to generate a plurality of baseband signals;
a baseband signal processing device, processing the baseband signals; and
a processor, for controlling operations of the RF signal processing device and the baseband signal processing device,
wherein when camping on a first cell of a first RAT and when receiving a mobile terminated (MT) or mobile originated (MO) service request, the processor further determines whether performing a RAT change procedure to switch from the first RAT to a second RAT is required, and
when determining that performing the RAT change procedure is required, the processor directly camps on a target cell of the second RAT, and transmits a MT or MO service response for responding with the MT or MO service request to the target cell.

2. The communications apparatus as claimed in claim 1, wherein when determining that performing the RAT change procedure is required, the processor further determines whether to perform a fast RAT change procedure, and when the processor determines to perform the fast RAT change procedure, the processor directly camps on the target cell of the second RAT and transmits the MT or MO service response to the target cell without notifying the first cell.

3. The communications apparatus as claimed in claim 1, wherein when determining that performing the RAT change procedure is required, the processor further determines whether to perform a fast RAT change procedure, and when the directly camps on the target cell of the second RAT and transmits the MT or MO service response to the target cell instead of to the first cell.

4. The communications apparatus as claimed in claim 1, wherein when determining that performing the RAT change procedure is required, the processor further determines the target cell from a plurality of neighboring cells of the second RAT.

5. The communications apparatus as claimed in claim 1, wherein the processor further receives system information of the target cell and camps on the target cell based on the received system information.

6. The communications apparatus as claimed in claim 1, wherein before receiving the MT or MO service request, the processor further receives a predetermined set of system information (SI) from a plurality of neighboring cells of the second RAT and stores the received predetermined set of SI in an SI early-reading database.

7. The communications apparatus as claimed in claim 6, wherein when determining that performing the RAT change procedure is required, the processor further determines the target cell from the neighboring cells of the second RAT, retrieves the predetermined set of SI of the target cell from the SI early-reading database, and camps on the target cell based on the retrieved predetermined set of SI.

8. The communications apparatus as claimed in claim 6, wherein the SI early-reading database comprises a plurality of records, and each record comprises information regarding a radio frequency carrier number of a specific neighboring cell, a base station identity code (BSIC) or a primary scrambling code (PSC) of the specific neighboring cell, the predetermined set of SI of the specific neighboring cell, and an identifier of the first cell.

9. The communications apparatus as claimed in claim 6, wherein the processor receives the predetermined set of SI of the neighboring cells in an idle mode.

10. The communications apparatus as claimed in claim 6, wherein the processor receives the predetermined set of SI of the neighboring cells in a connected mode.

11. The communications apparatus as claimed in claim 2, wherein the processor determines to perform the fast RAT change procedure when an SI early-reading database storing a predetermined set of previously received system information (SI) of a plurality of neighboring cells of the second RAT regarding the first cell exists.

12. A method for a communications apparatus in a network environment comprising a plurality of cells belonging to different radio access technologies (RATs) to rapidly switch between different RATs, comprising:
camping on a first cell of a first RAT;
receiving a mobile terminated (MT) or mobile originated (MO) service request;
determining whether performing a RAT change procedure to switch from the first RAT to a second RAT is required; and
when performing the RAT change procedure is required, directly camping on a target cell of the second RAT and transmitting a MT or MO service response for responding with the MT or MO service request to the target cell.

13. The method as claimed in claim 12, further comprising:
determining whether to perform a fast RAT change procedure when performing the RAT change procedure is required; and
when determining to perform the fast RAT change procedure, directly camping on the target cell of the second RAT and transmitting the MT or MO service response to the target cell without notifying the first cell.

14. The method as claimed in claim 12, further comprising:
determining whether to perform a fast RAT change procedure when performing the RAT change procedure is required; and
when determining to perform the fast RAT change procedure, directly camping on the target cell of the second RAT and transmitting the MT or MO service response to the target cell instead of to the first cell.

15. The method as claimed in claim 12, further comprising:
determining the target cell from a plurality of neighboring cells of the second RAT.

16. The method as claimed in claim 12, further comprising:
receiving system information of the target cell,
wherein the step of camping on the target cell is performed based on the received system information.

17. The method as claimed in claim 12, further comprising:
receiving a predetermined set of system information (SI) from a plurality of neighboring cells of the second RAT; and
storing the received predetermined set of SI in an SI early-reading database.

18. The method as claimed in claim 17, further comprising:
determining the target cell from the neighboring cells of the second RAT when determining that performing the RAT change procedure is required;
retrieving the predetermined set of SI of the target cell from the SI early-reading database; and
camping on the target cell based on the retrieved predetermined set of SI.

19. The method as claimed in claim 17, wherein the SI early-reading database comprises a plurality of records, and each record comprises information regarding a radio frequency carrier number of a specific neighboring cell, a base station identity code (BSIC) or a primary scrambling code (PSC) of the specific neighboring cell, the predetermined set of SI of the specific neighboring cell, and an identifier of the first cell.

20. The method as claimed in claim 17, wherein the step of receiving the predetermined set of SI of the neighboring cells is performed when the communications apparatus operates in an idle mode.

21. The method as claimed in claim 17, wherein the step of receiving the predetermined set of SI of the neighboring cells is performed when the communications apparatus operates in a connected mode.

22. The method as claimed in claim 13, wherein the fast RAT change procedure is determined to be performed when an SI early-reading database storing a predetermined set of previously received system information (SI) of a plurality of
